(19) United States
(12) Patent Application Publication
(10) Pub. No.: US 2004/0114758 A1
(43) Pub. Date: Jun. 17, 2004

(54) Digital system prepared for coble with 1394 de-scrambling module

(76) Inventors: Eric Stephen Carlsgaard, Zionsville, IN (US); Ed Marshall Milbourn, Greenfield, IN (US)

Correspondence Address: Joseph S Tripoli, Thomson Multimedia Licensing Inc, PO Box 5312, Princeton, NJ, 08543-5312, US

(21) Appl. No.: 10/474,939

(22) PCT Filed: Apr. 15, 2002
(86) PCT No.: PCT/US02/11972

(51) Int. Cl. H04N 7/167

(52) U.S. Cl. 380/210

(57) ABSTRACT

A digital, cable ready television functions without a standard point-of-deployment (POD) interface module. The television utilizes an IEEE 1394 compatible interface and module to perform processing functions, such as descrambling scrambled signals, and providing electronic program guide (EPG) information. The television receives an input signal containing scrambled signals. The scrambled signals are switched out of the main transport data stream to the descrambler via the IEEE 1394 compatible interface. The scrambled signals are descrambled in accordance with permission information embedded in the input signal and recombined with the main transport data stream, via the IEEE 1394 compatible interface, wherein descrambled signals replace scrambled signals. The combined signal is provided to a display/audio device in any appropriate format, such as HD-MPEG. The IEEE 1394 compatible interface module may also provide copy protected content.

### BACKGROUND

Current digital cable systems use a standard point-of-deployment (POD) interface. This interface typically requires a high number of connectors (e.g., pin connectors) and considerable interaction with the television receiver. Accordingly, the POD module requires a large amount of circuitry and the television receiver requires a large amount of software to be compatible with the POD module. These current digital ready systems are complex and expensive. Thus, a need exists for a digital cable ready system, which can function without a standard POD interface.

### SUMMARY OF THE INVENTION

A digital, cable ready system functions without a standard point-of-deployment (POD) interface module. The system includes a first processing portion configured to receive an input signal. The system also includes a second processing portion configured to descramble a scrambled signal component associated with the input signal. The first processing portion is coupled to the second processing portion by an IEEE 1394 compatible interface.

### BRIEF DESCRIPTION OF THE DRAWINGS

The invention is best understood from the following detailed description when read in connection with the accompanying drawings. Included in the drawings are the following figures:

FIG. 1 is a functional block diagram of a processing system in accordance with an embodiment of the present invention; and

FIG. 2 is a flow diagram of an exemplary process for processing a television signal in accordance with an embodiment of the present invention.

### DETAILED DESCRIPTION

A description of the Institute of Electrical and Electronics Engineers (IEEE) 1394 interface may be found in the IEEE 1394-1995 standard. Briefly, the IEEE 1394 supports data transfer rates of up to 400 million bits per second (Mbps). The IEEE 1394 also supports isochronous data (data provided at a guaranteed data rate), which is advantageous for video applications. An IEEE 1394 comprises a plurality of layers, each performing specific functions. These layers include a transaction layer, a link layer, and a physical layer (Phy). The transaction layer defines certain high level functions, such as how data is transferred between nodes and how errors are handled. The link layer communicates with the transaction layer and provides addressing, data checking, and data framing information. The physical layer provides the physical interface between a node and the bus itself and translates signals from the link layer into appropriate electrical signals for the 1394 bus.

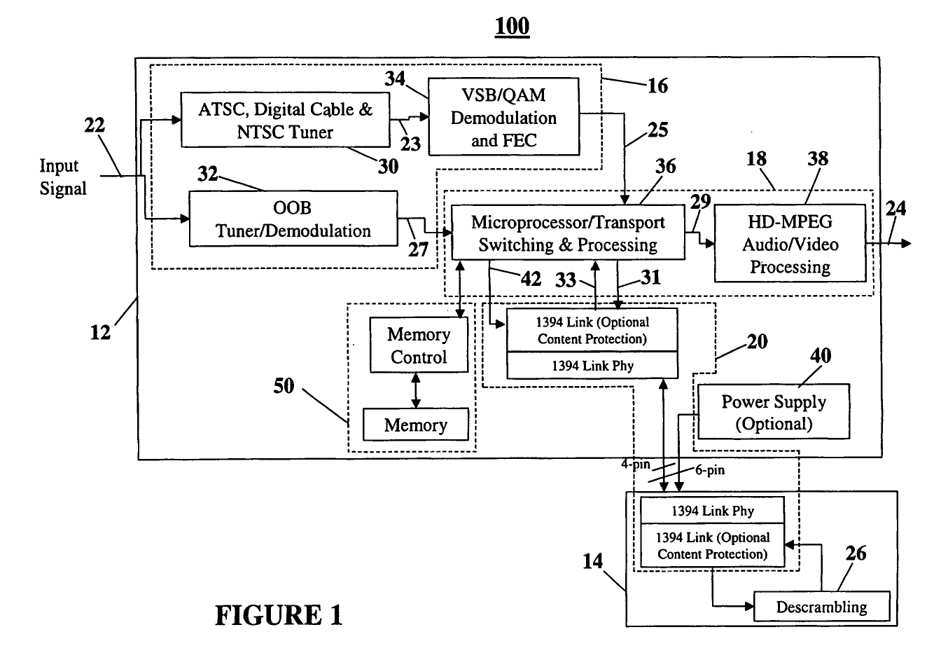

FIG. 1 is a functional block diagram of a processing system 100, as described herein, comprising an IEEE 1394 link. In one embodiment, processing system 100 performs the functions of a digital cable ready television receiver with a 1394 link-based de-scrambling capability. System 100 comprises a first processing portion 12 for tuning and demodulating the input signal 22, and providing audio and/or video data (signal 24) in the form of a transport stream, and a second processing portion 14 for performing functions such as descrambling, providing signals in accordance with granted permission (e.g., pay-per-view channel), and providing electronic program guide (EPG) information. In an exemplary embodiment, the processing portion 12 may be incorporated in a digital ready cable television. In this embodiment, the processing portion 12 does not require a point-of-deployment (POD) interface to the second processing portion 14, or a POD module to accomplish the above described functions (e.g., descrambling, providing permitted signals, providing EPG information). As know in the art, typical POD modules and interfaces utilize complex data protocols and a large number of connector pins, such as used in PCMCIA cards.

System 100 accomplishes the functions of descrambling, providing signals in accordance with granted permission, and providing EPG information, utilizing an IEEE 1394 interface with only 4 or 6 pin connectors. These functions are accomplished utilizing processing portion 14 via an IEEE 1394 interface. The first processing portion 12 is capable of receiving the input signal 22 and providing the output signal 24. The input signal 22 may comprise a digital television signal, such as a cable television (CATV) signal, a broadcast signal, and/or a satellite signal. Furthermore, the input signal 22 may comprise an out-of-band (OOB) signal and a service signal. An OOB signal may comprise conditional access and management messages, interactive program guide information, and/or other private data, for example. A service signal comprises the remainder of the input signal 22, such as network broadcast channels, pay channels, pay-per-view channels, Internet service channels, scrambled channels, or any combination thereof, for example. The input signal 22 may be formatted in any of several formats, such as National Television System Committee (NTSC), American Television Systems Committee (ATSC), and/or digital cable, for example. The output signal 24 may comprise a video signal and/or an audio signal. Output signal 24 may be formatted in any of several formats. For example, output signal 24 may be formatted in accordance with Moving Picture Experts Group (MPEG) formats. Descriptions of some MPEG formats may be found in ISO/IEC standards 11172-1 (MPEG-1 systems), 11172-2 (MPEG-1 video), 11172-3 (MPEG-1 audio), 11172-4 (MPEG-1 compliance testing), 11172-5 (MPEG-1 technical report), 13818-1 (MPEG-2 systems), 13818-2 (MPEG-2 video), 13818-3 (MPEG-2 audio), and 13818-4 (MPEG-2 compliance), for example.

Processing portion 14 comprises a portion of 1394 link 20 and a de-scrambler 26. The 1394 link 20 couples processing portion 12 with processing portion 14. Optionally, 1394 link provides content protection, such as 5C digital transmission content protection for example, for protecting signals from being tampered with, copied, and/or intercepted. A description of 5C digital transmission content protection may be found in a document entitled “5C Digital Transmission Content Protection White Paper”, Revision 1.0, Jul. 14, 1998, Copyright 1998 by Hitachi Ltd., Intel corporation, Matsushita Electric Industrial, Co. Ltd., Sony corporation and Toshiba Corporation. Processing portion 14 may be integrated within processing portion 12, or may be external to processing portion 12, as shown in FIG. 1.

Processing portion 12 comprises a third processing portion 16, a fourth processing portion 18, a portion of the 1394 link 20, and an optional power supply 40 for providing power to processing portion 14. Processing portion 16 tunes and demodulates portions of the input signal 22. Processing portion 16 comprises tuner 30 for tuning a portion of the input signal 22, such as the service signal, and tuner/demodulator 32 for tuning another portion of the input signal 22, such as the OOB signal. Processing portion 16 also comprises demodulator 34 for demodulating a portion of the input signal 22, such as the service signal, and for optionally providing forward error correction (FEC). Processing portion 18 comprises a transport/switching processor 36 and an audio/video processor 38. As described in more detail herein, the transport/switching processor 36 is configured to receive tuned and demodulated portions (signals 25 and 27) of the input signal 22. The transport/switching processor 36 provides selected portions of the tuned/demodulated signals 25 and 27 to the processing portion 14 (signal 31) for further processing (e.g., descrambling) and recombines portions of the signals (e.g., descrambled signals) provided by the processing portion 14 (signal 33) with the data transport stream (signal 29) provided to audio/video processor 38.

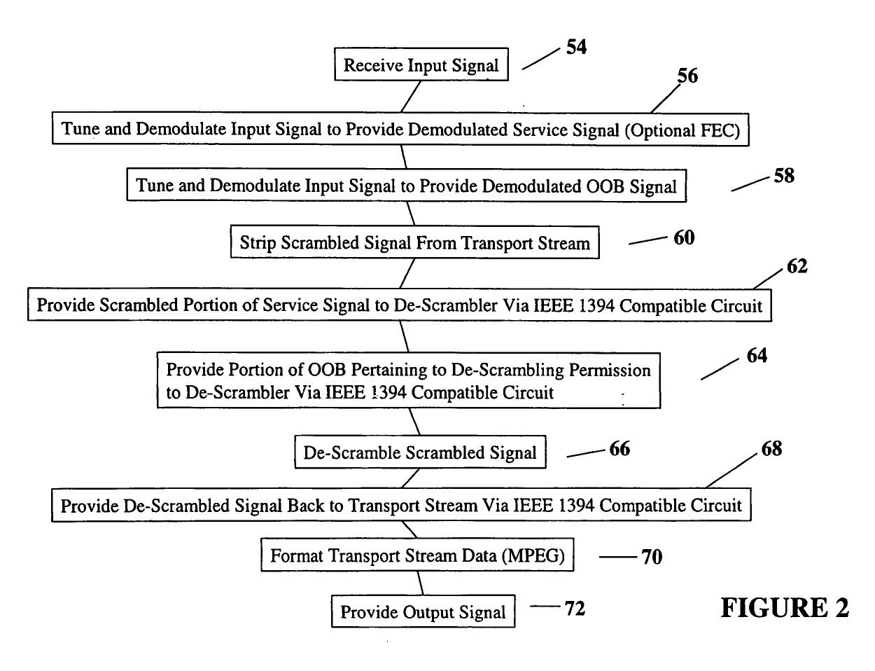

FIG. 2 is a flow diagram of an exemplary process for processing a television signal.

Referring to FIGS. 1 and 2, an input signal 22 is received at step 54. The input signal 22 is provided to main tuner 30 and OOB tuner/demodulator 32, concurrently. Tuner 30 filters and tunes the input signal 22 (e.g., the service signal portion) at step 56 in accordance with an ATSC format, an NTSC format, a digital cable format, or a combination thereof, for example.

The tuned signal 23 is provided to the demodulator 34 (step 56). Demodulator 34 demodulates the tuned signal 23 and optionally provides FEC processing (step 56) to produce an output signal 25, output from module 34. Tuner/demodulator 32 tunes and demodulates the OOB signal portion of the input signal 22 at step 58 to provide signal 27. Many types of modulation/demodulation schemes are appropriate. Examples include quadrature amplitude modulation (QAM) and corresponding demodulation, quadrature phase shift keying (QPSK) demodulation and corresponding demodulation, and vestigial sideband (VSB) modulation and corresponding demodulation. For example, demodulator 34 may perform quadrature amplitude modulation (QAM) demodulation on the service signal, and tuner/demodulator 32 may perform quarternine phase shift keying (QPSK) demodulation on the OOB signal.

The tuned and demodulated signals 25 and 27 are provided to transport/switching processor 36 of processing portion 18. Transport/switching processor 36 may comprise any appropriate processor, such as a microprocessor, a computer, a specifically designed processor, or a combination thereof. The tuned/demodulated service signal 25 may comprise a plurality of scrambled and unscrambled (in the clear) channels. The tuned/demodulated signal 27 may comprise information pertaining to each channel in signal 25, such as whether the channel is scrambled or in the clear, if the particular user has permission to view that channel, if the particular user has permission to descramble that channel, and EPG information. The tuned/demodulated service signal 25 is provided to transport/switching processor 36 in the form of a transport stream, which may comprise a plurality of channels. Selected portions of the tuned/demodulated signals 25 and 27 are provided to the processing portion 14 at steps 60, 62, and 64. Transport/switching processor 36 provides portions of the service signal that are scrambled to the 1394 link 20 at steps 60 and 62. That is, selected portions of the transport data stream (signal 25), such as scrambled audio and/or video signals, provided by demodulator 34 are switched out of the main transport path (i.e., the path comprising both signals 25 and 27, not shown in FIG. 1) by transport/switching processor 36, and provided to the 1394 link circuit 20 (signal 31). Selection of portions of the signal 25 is accomplished in accordance with corresponding portions of the tuned/demodulated signal 27, comprising information related to the data in signal 25. For example, the tuned/demodulated signal 27 may comprise a portion indicating that a channel contained in signal 25 is scrambled. The transport/switching processor 36 analyzes the signal 27, and accordingly, provides the corresponding scrambled channel to the processing portion 14 as part of signal 31. The scramble channel is then descrambled (if permission is granted) by descrambler 26, and provided back to the transport/switching processor 36 as part of signal 33. The descrambled signal is then recombined with the main transport stream as part of signal 29, and provided to the audio/video processor 38. The scrambled signals (signal 31) may be provided by a serial interface, a parallel interface, or a combination thereof. The 1394 link may be in the form of an integrated circuit, may comprise discrete components, or a combination thereof. The 1394 link 20 (processing module 52) may optionally provided content protection to the received service signal. The service signal is provided to the portion of the 1394 link contained in processing portion 14 by the portion of the 1394 bus link contained in processing portion 12. This signal is provided to the de-scrambler 26 to be de-scrambled at step 66. The de-scrambled transport stream and optional 5C protection data is returned through the 1394 link at step 68. The optional 5C protection is stripped from the de-scramble transport stream by transport/switching processor 36 and then provided to audio/video processor 38. In the clear portions (not scrambled) of the transport stream provided by demodulator 34 are provided to transport/switching processor 36, which in turn provides the in the clear signals directly to audio/video processor 38, without being provided to the 1394 bus link. The transport steam data is formatted by audio/video processor 38 at step 70. The output signal 24 is then provided by audio/video processor 38 at step 72. Audio/video processor 38 may comprise any appropriate processor for processing audio and/or video signals, such as a processor capable of processing the transport stream and providing video and/or audio signals formatted in accordance with the MPEG formats such as a high definition MPEG (HD-MPEG) format, for example.

The OOB signal is provided by tuner/demodulator 32 (signal 27) to transport/switching processor 36 at step 58. The OOB signal is incorporated into the transport stream comprising the service signal and is provided by transport/switching processor 36 to the 1394 link 20 and provided to the external de-scrambler 26 using the isochronous data mode of the 1394 link. Alternatively, the OOB signal is provided to the 1394 link via an auxiliary interface 42 and provided to the external de-scrambler 26 using the asynchronous data mode of the 1394 link. The OOB signal is provided in these two formats for compatibility with existing systems. The OOB signal comprises user data, such as permission to de-scramble scrambled channels, channel guide information, and other terrestrial broadcasts (ATSC), for example. The user data may be processed in accordance with any of several techniques. For example, in one embodiment, all of the user data is provided as part of the transport stream to the 1394 link at step 64. The permission information for channel de-scrambling, is used to determine which channels the de-scrambler 26 may de-scramble (step 64). Other user data, such as user guide information, is inserted back into the transport stream, in place of null packets, for example. This other user data is then processed in a manner similar to the processes used for digital television and other terrestrial broadcasts (ATSC), and may be converted into graphics information for eventual display.

In another embodiment, only the de-scrambling permission related portion of the user data is provided to the 1394 link at step 64. The remainder of the user data is stored in memory, such as memory circuitry 50. This remainder of the user data is then recombined with the transport stream and processed as described above. This embodiment simplifies the processing complexity of processing portion 14 as compared to the previous embodiment.

In one embodiment of the system 100, processing portion 14 may comprise a power source (not shown in FIG. 1). In this configuration, processing portion 14 may be coupled to processing portion 12 using a 4-pin connector, as shown in FIG. 1. In another embodiment, processing portion 14 may receive power from optional power supply 40. In this configuration, processing portion 14 may be coupled to processing portion 12 using a 6-pin connector, as shown in FIG. 1, wherein the two additional pins may be used to provide power to processing portion 14 from power supply 40.

Advantages of a processing system comprising an IEEE 1394 compatible de-scrambler, as described herein, over current systems include reduced interface circuitry, reduced protocol complexity, less hardware in the form of pin connectors, and less software within the television receiver. As a result, system costs are reduced. The system allows for digital cable ready television receivers to function without the use of standard POD interface modules. The system provides concurrent asynchronous and isochronous transport on the same interface. The system also provides self power capability via optional power supply 40. Furthermore, the external processing portion 14 can be attached and/or detached from processing portion 12 without removing power from either processing portion 12 or 14 (live attach/detach).

Although illustrated and described herein with reference to certain specific embodiments, the present invention is nevertheless not intended to be limited to the details shown. Rather, various modifications may be made in the details within the scope and range of equivalents of the claims and without departing from the spirit of the invention.

1. A processing system comprising:
a first processing portion configured to receive an input signal; and
a second processing portion configured to de-scramble a scrambled signal component associated with said input signal, wherein said first processing portion is coupled to said second processing portion by an IEEE 1394 compatible interface.

2. A processing system in accordance with claim 1, wherein said scrambled signal is provided to said second processing portion in accordance with at least one of an IEEE 1394 compatible asynchronous data mode and an IEEE 1394 compatible isochronous data mode.

3. A processing system in accordance with claim 1, said first processing portion further configured to provide an output signal, wherein said first processing portion comprises:
a third processing portion configured to receive said input signal and provide at least one of a demodulated out-of-band (OOB) signal, a demodulated service signal, and a forward error correction (FEC) signal;
a fourth procession portion configured to receive said at least one of said OOB signal, said demodulated service signal, and said FEC signal and configured to provide said output signal and at least one of an auxiliary data signal and a transport stream signal;
an IEEE 1394 compatible circuit configured to receive said at least one said auxiliary data signal and said transport stream signal and configured to provide said scrambled signal to said second processing portion.

4. A processing system in accordance with claim 1, wherein said first processing portion comprises a power supply for providing power to said second processing portion.

5. A signal processing system in accordance with claim 1, wherein said IEEE 1394 compatible interface provides copy protected content.

6. A method for processing a signal, said method comprising the steps of:
receiving said signal comprising at least one of a scrambled signal and an out-of-band (OOB) signal, wherein said OOB signal comprises information pertaining to permission to descramble said at least one scrambled signal; and
processing said received signal to provide at least one selected scrambled signal to a descrambler via an IEEE 1394 compatible circuit in accordance with said OOB signal.

7. A method in accordance with claim 6, further comprising the step of descrambling said at least one selected scrambled signal.

8. A method in accordance with claim 7, further comprising the step of combining said descrambled at least one selected scrambled signal with said processed received signal, wherein each descrambled signal replaces a corresponding scrambled signal.

9. A method in accordance 8, further comprising the step of providing said combined signal as an output signal.

10. A method in accordance with claim 6, wherein portions of said OOB signal are provided to said descrambler in accordance with at least one of an IEEE 1394 compatible asynchronous data mode and an IEEE 1394 compatible isochronous data mode.

11. A method in accordance with claim 6, wherein said IEEE 1394 compatible circuit provides copy protected content.
